(19) United States
(12) Patent Application Publication
(10) Pub. No.: US 2025/0162108 A1
(43) Pub. Date: May 22, 2025

(54) Clamping Ring for a Fitting and Fitting with a Clamping Ring

(71) Applicant: Viega Technology GmbH & Co. KG, Attendorn (DE)

(72) Inventors: Simon Hofrichter, Kirchhundem (DE); Mario Pace, Lennestadt (DE); Paul Köster, Olpe (DE)

(21) Appl. No.: 18/955,249

(22) Filed: Nov. 21, 2024

(30) Foreign Application Priority Data
Nov. 22, 2023 (DE) 10 2023 132 504.3

(51) Int. Cl. B25B 5/14; B25B 5/08

(52) U.S. Cl. CPC B25B 5/147; B25B 5/08

(57) ABSTRACT

A clamping ring for a fitting for a connection to a pipe, having a plurality of ring elements. The ring elements being designed to hold and/or fix a pipe to be inserted. At least one ring element is designed as a inhibiting element with a radially inwardly directed cam. The cam is designed to be elastically pivotable outwards in the radial direction and that the cam has a radially inwardly directed curved surface. The invention also relates to a fitting and a system including a fitting and a pipe. The clamping ring leads to improved self-locking of the inserted pipe.

### CROSS-REFERENCE TO RELATED APPLICATION

This application claims priority to German Patent Application No. 10 2023 132 504.3 filed Nov. 22, 2023, the disclosure of which is hereby incorporated by reference in its entirety.

### BACKGROUND OF THE INVENTION

### Field of the Invention

The invention relates to a clamping ring for a fitting for a connection to a pipe, a fitting for a connection to a pipe with a clamping ring and a system comprising a fitting and a pipe.

The technical field relevant to the present invention is the on-site installation of piping systems, in which a piping system consisting of pipe sections and fittings is generally installed for conducting and guiding a fluid, i.e. a liquid or a gas. A fitting is generally understood to be a connecting piece for a pipeline, and a fitting is most frequently used to connect two or more pipe sections. Accordingly, the fitting preferably has two or more press sections, for example in the form of pressing sleeves. The most common fittings include straight connections, changes of direction in the form of pipe bends, reducers, branches such as T-pieces or crossings. However, a fitting is also a pipe connection for a fitting or other component. For example, thermometers or pressure gauges as fittings only have one connection for one pipe section. The fitting of a fitting therefore only has a press section to connect a pipe section to the fitting.

Press connections are used to connect the pipe sections to the fittings and other components, in which a press section of a fitting is formed radially inwards by means of a press jaw when the pipe section is inserted, so that a permanent and tight, possibly even non-detachable connection is created. The fittings can be provided with a sealant, for example an O-ring, which ensures the tightness of the connection, or can also be formed by means of direct contact between the materials of the pipe section and the fitting, for example metal-to-metal sealing.

The press technology for radial forming of the press section is primarily radial press systems as well as press systems that use radial-axial pressing, whereby a part of the fitting is axially displaced during the pressing process in order to effect radial forming.

The piping systems generally described above are used in particular to transport drinking or heating water, gas for operating a heating system or industrial gases. In principle, any fluid medium can be transported in the pipelines.

In the case of press fittings, a distinction is made as to whether a pipe is sealed and fixed from the outside during pressing or whether at least part of the fitting, for example in the form of a support sleeve, stabilizes the pipe to be sealed from the inside. The present invention relates to both types of fittings.

### Description of Related Art

Solid materials, in particular metallic materials, are used as materials for pipes to be sealed from the outside. Solid plastics can also be used as solid materials. Suitable materials include, in particular, metals such as stainless steels like ferritic steels like 1.4520, 1.4521, austenitic steels like 1.4404, duplex steels like 1.4462, gunmetal, SiBr, copper, but also solid plastics such as cross-linked polyethylene (PE-X), polyethylene of increased temperature resistance (PE-RT), polyvinyl chloride (PVC) and polypropylene (PP) with corresponding wall thicknesses. Furthermore, multilayer composite pipes can be sufficiently rigid for sealing from the outside, for example with a thicker aluminum layer, and fiber-reinforced pipes can also be used. Pipes to be sealed from the inside can be made from the same plastics or from a composite of plastic and metal layers, but with a thinner wall thickness so that flexibility is ensured by the geometric design.

The described fittings and their components are preferably made of a metal in order to ensure formability with sufficient hardness and dimensional stability after forming. The metals that can be used are those already mentioned for the rigid pipes, for example stainless steels such as ferritic steels like 1.4520, 1.4521, austenitic steels like 1.4404, duplex steels like 1.4462, gunmetal, SiBr, copper.

However, the described fittings and their components can also be made of a non-metallic material or plastic if the non-metallic material provides sufficient properties for pressing and permanent connection with pipes. The following materials, for example, are suitable in this case: Cross-linked polyethylene (PE-X), silane-cross-linked polyethylene (PE-Xb) or physically cross-linked polyethylene (PE-Xc), polyethylene of increased temperature resistance (PE-RT), polyvinyl chloride (PVC), polypropylene (PP) with corresponding wall thicknesses, polyphenylsulfone (PPSU), polyetheretherketone (PEEK) or polyaryletherketone (PAEK), aliphatic bio-based polyamide (PA410, PA12, PA12-GF30) or polypropylene random copolymer with modified crystal structure and increased temperature resistance (PP-RCT).

Fittings for connecting to a pipe to be sealed from the outside can have various designs. As a rule, a sealing ring, for example an O-ring, is provided to seal the fitting against the outside of the pipe. Furthermore, holding elements and/or fixing elements are provided which fix the pipe in the required position relative to the fitting before and after pressing.

For example, a fitting for a connection to a pipe has a base body with a structure with a stop element formed in the base body on the circumference and projecting inwards, with a pressing sleeve connected to the base body and forming an outer contour, the pressing sleeve having a chamber directed inwards towards the pipe to be accommodated, with a clamping ring arranged in the chamber and with a sealing element, the pressing sleeve being suitable, together with the clamping ring and the sealing element, for sealing the pipe to be connected.

The base body of the clamping ring is made of plastic and has a closed ring shape. In order to insert the clamping ring into a fitting or into the undercut chamber of the pressing sleeve, it must be compressed radially, for which purpose axially extending slots are provided that enable the compression.

The problem with the previously described design of the fittings and the clamping rings used is that on the one hand, a specific clamping ring must be manufactured for each fitting. On the other hand, the production of the clamping rings is complex because holding elements have to be formed and/or fixing elements integrated into the round shape and numerous slots have to be made to ensure formability for the installation. In addition, the arrangement of slots means that there is no continuous contact surface for the O-ring, which can shorten the service life of the connection.

After inserting a pipe into the fitting, the pipe is held and centered by the clamping ring. The insertion force essentially corresponds to the extraction force, so that no defined self-holding of the pipe in the fitting is achieved. Although the holding force can be predetermined by contact between the seal and the pipe, the holding force cannot be clearly and reliably predetermined due to tolerance fluctuations in the seals.

### SUMMARY OF THE INVENTION

The present invention is therefore based on the object of providing a clamping ring and a fitting with such a clamping ring, whereby the self-holding of an inserted pipe is improved. In addition, the object is to simplify the manufacture of the clamping ring and to make its use more flexible.

The above object is solved in accordance with the invention by a clamping ring for a fitting for a connection to a pipe with a plurality of ring elements, wherein the ring elements are designed for holding and/or fixing a pipe to be inserted, wherein at least one ring element is designed as an inhibiting element with a radially inwardly directed cam, wherein the cam is designed to be elastically deformable outwards in the radial direction and wherein the cam has a radially inwardly directed curved surface.

According to the invention, the above technical problem is also solved by a fitting for a connection to a pipe with a base body, with a stop element formed in the base body on the circumference and projecting inwards, with a pressing sleeve connected to the base body, the pressing sleeve having a chamber directed inwards towards the pipe to be received, with a clamping ring arranged in the chamber, wherein the clamping ring consists of a plastic and has a plurality of ring elements, and with a sealing element, wherein the pressing sleeve is suitable, together with the clamping ring and the sealing element, for sealing the pipe to be connected and wherein a clamping ring as described above is provided.

In the fitting, the inwardly curved surface of the cam faces the pipe to be inserted and lies against the outside of the pipe. As the pipe moves into the fitting, the cam is deformed outwards and, if necessary, swivels and remains in contact with the pipe as it swivels due to the curved surface.

The cam is preferably aligned at an angle of less than 90° to the axis of the pipe to be inserted in the direction of insertion of the pipe. Due to the contact with the pipe, the cam must be deformed outwards in the direction of its inclined alignment when it is pushed in and is therefore pressed against the pipe. This increases the contact pressure on the pipe and the static friction increases.

If the pipe is unintentionally pulled out of the fitting, the cam is also moved due to the static friction, whereby the inhibiting element as a whole is not or only slightly moved axially. The movement of the cam in the opposite direction to its oblique alignment results in further deformation, which causes an additional counterforce compared to the pull-out. This increases the extraction force compared to the insertion force and improves self-holding. A lower insertion force makes it easier to connect the pipe and fitting and a greater extraction force improves self-retaining properties.

The design of the inhibiting element as part of the clamping ring facilitates pre-assembly, in particular the pre-assembly of an installation on the wall or in a shaft. The unpressed connection between the pipe and fitting is then better protected against slipping apart due to the higher pull-out force.

Preferably, at least three holding elements with cams are provided and the cams form a diameter smaller than the outer diameter of the pipe to be inserted on the radially inward side. As the fittings and the clamping rings to be installed in them are each designed for specific nominal diameters, these can also be defined without an existing pipe. As the inside diameter is smaller than the outside diameter of the pipe, the cams are guaranteed to rest on the outside of the pipe.

The clamping ring can be designed in various ways.

At first, a plurality of hinge elements can be provided for the pivotable connection of two ring elements in each case, whereby the ring elements have a strip shape by means of the hinge elements and whereby the ring elements can assume a flat shape or a laterally open ring shape.

The clamping ring can therefore be advantageously manufactured as a flat product, whereby the individual ring elements are movably connected to each other by means of the hinge elements. The ring elements thus form individual segments of the press ring. The term “flat product” or “flat” means that the ring elements can be brought into an elongated, flat and strip-like shape by the hinge elements and the ring elements can lie essentially flat on a surface.

The hinge elements are preferably designed as film hinges integral with the ring elements, so that the clamping ring has a one-piece basic shape. The clamping ring can therefore preferably be produced as an endless profile using a plastic extrusion process. The design as a flat strip-shaped clamping ring also facilitates the assembly of additional elements such as cutting elements, which can be integrated more easily after the strip has been manufactured than if the clamping ring is in ring form.

The ring elements connected to each other by means of the hinge elements can be folded from a flat shape into a ring shape. For installation in a fitting, the clamping ring is therefore cut to a predetermined length and then inserted into the fitting in an open ring shape, similar to a C-shape. For installation, the shape of the clamping ring can be slightly reshaped radially inwards due to the special design with the hinge elements and the associated special elasticity. If necessary, the free ends of the clamping ring can overlap during installation and unfold into a ring shape when inserted into the chamber of the pressing sleeve. This makes installation easier, particularly in fittings with small diameters.

When the fitting is pressed radially using a pressing tool, the hinge elements and the adjacent areas of the ring elements form the deformation zones. The deformation zones are therefore evenly and possibly even symmetrically distributed in the circumferential direction. During the pressing process, the deformation zones then ensure a uniform application of force in the azimuthal direction and, in particular, tangential displacement of the ring elements is limited or even completely avoided. Particularly in the design of the ring element as a fixing element with cutting element described below, it is advantageous that tangential movement of the cutting element is restricted or avoided.

In addition, the compressed hinge elements together with the ring elements create a continuous sealing contact surface in the pressed state, which facilitates the positioning and securing of the sealing element.

The ring elements described above and thus the clamping ring as a whole are preferably made of one of the following materials: cross-linked polyethylene (PE-X), silane-cross-linked polyethylene (PE-Xb) or physically cross-linked polyethylene (PE-Xc), polypropylene (PP), polyphenylsulfone (PPSU), polyetheretherketone (PEEK) or polyaryletherketone (PAEK), aliphatic bio-based polyamide (PA410, PA12, PA12-GF30) or polypropylene random copolymer with modified crystal structure and increased temperature resistance (PP-RCT).

Preferably, the ring elements have a partially cylindrical outer surface. This means that the ring elements adapt to the cylindrical shape of the fitting in the area of the chamber of the pressing sleeve, at least in sections on the outside. In the flat strip-like shape, the ring elements can therefore rest on a flat surface with a section of their partially cylindrical outer surface.

Furthermore, the ring elements can have lateral surfaces in the azimuthal direction that are tapered inwards towards each other, at least in sections, in the radial direction. This allows the ring elements together with the hinge element connecting them to form a V-groove between them. This V-groove allows for an easier circular arrangement of the ring elements. Furthermore, an additional space between the ring elements provides a volume that can be filled with material from the ring elements during pressing. This leads to an even distribution of the pressing force, which is permanently exerted by the pressing sleeve via the clamping ring on the outside of the pipe.

In a further preferred manner, the ring elements have a predetermined azimuthal length, so that by cutting the strip of hinge elements into strips with at least two different numbers of ring elements for at least two clamping rings for fittings with at least two different standard widths is possible. This makes it possible to use the clamping ring in different nominal widths by cutting it to different lengths. The clamping ring should preferably fill a full circle within the fitting, firstly to ensure a continuous contact surface for the sealing element and secondly to ensure a tight fit of the clamping ring before pressing, for example to prevent it from falling out during transportation.

To enable multiple use of a clamping ring described above, the pitch of the clamping ring is selected so that the full circumference can be achieved with two or more nominal widths.

Furthermore, the ring elements can have a seal seat at the end facing a seal to be inserted. The seal seat is preferably realized by an axially protruding holding element, which limits the space spanned by the ring element radially inwards and thus restricts the freedom of movement of the seal. However, the ring element can also be round in some sections and restrict the freedom of movement of the seal solely through axial contact with the seal.

On the one hand, the seal seat improves seal protection by limiting or preventing the seal from being pushed out in an axial direction when the fitting is pressed. On the other hand, the seal seat prevents the seal from being pushed out by axial forces during pipe insertion. In addition, the position of the seal is also secured against displacement in the unpressed state in the event of pressure differences if the seal is sucked in in the axial direction due to pressure differences.

As a further alternative, the clamping ring with its ring elements can be designed in one piece as a ring that is open on one side. Due to the open ring structure, the clamping ring can be compressed for insertion into a fitting. This makes it easier to install the clamping ring. The clamping ring is therefore manufactured as a single piece for a given fitting.

The ring elements of the clamping ring can perform the same or different functions in addition to the function of the locking elements and can therefore be designed differently. The different functions can be realized alternately or otherwise alternately by the adjacent ring elements.

In a first preferred embodiment, the ring elements are partially designed as holding elements and the ring elements have radially inwardly directed, preferably elastically designed, guiding elements for centering and, if necessary, retaining a pipe to be inserted. In this way, the holding elements serve to center the pipe when the pipe is inserted into a fitting and the clamping ring arranged therein, and to hold the pipe with defined assembly forces after insertion and before the fitting is pressed.

The centering of the pipe during insertion into the fitting is also preferably improved by the fact that at least two guiding elements projecting radially inwards to different extents are formed one behind the other in the axial direction. This results in a first centering and a second centering one after the other during the insertion of the pipe. The first guiding element, which is distal from the fitting, can project less inwards than the proximal guiding element, so that good guidance to the correct position for pressing is achieved, particularly for pipes inserted at an angle. In addition, the various guiding elements hold the inserted pipe after assembly and before pressing.

The design of the guiding elements leads to defined assembly forces and therefore also to improved haptic control when inserting a pipe into the fitting, especially with a two-stage design of two guiding elements that protrude inwards at different distances. The user can check more precisely by touch whether the pipe has been inserted correctly and far enough.

Thanks to the geometry of the guiding elements with defined material thickness and material properties, a consistent assembly and pipe holding force can be achieved regardless of the tolerances of the pipe.

Due to the centering function, in particular together with the seal seat described above for more precise positioning of the seal, the guiding elements ensure that the outer surface of the pipe only comes into contact with the inside of the seal to a small extent or preferably not at all during insertion of the pipe. This reduces the risk of damage to the seal and low insertion forces can be achieved even without the use of lubricants such as silicone oil. It is therefore possible to use seals without paint-wetting substances (LABS-free) and without silicone.

The functionality of an intentionally leaking arrangement of pipe and seal in the uncompressed state is also improved by the described design, as the positioning and holding of the pipe relative to the seal is improved. If, for example, the seal has a sufficiently larger internal diameter than the external diameter of the pipe, an intended leak in the unpressed state can be achieved and ensured.

As an alternative to the holding elements, the ring elements can also be partially designed as fixing elements, whereby the fixing elements each have at least one cutting element for fixing a pipe to be inserted. After insertion and after pressing the fitting, the pipe is secured by the fixing elements to prevent the pipe from being pulled out of the fitting.

In a preferred manner, the cutting elements lie on the inside of the pipe along a linear area, in particular a cutting edge, and on the outside of the chamber of the pressing sleeve along a flat area. This means that when the fitting is pressed, the radially inward force can be effectively used to cut the cutting element into the wall of the pipe.

In a preferred design of the clamping ring, the fixing elements have protective elements arranged next to the cutting elements in the circumferential direction, with the protective elements projecting further inwards in the radial direction than the cutting elements. This protects the pipe from contact with the cutting elements during insertion and before pressing and largely prevents damage to the surface of the pipe in unwanted positions. The protective elements therefore work in a similar way to the guiding elements described above.

In a particularly preferred manner, some of the ring elements are designed as inhibiting elements and additionally some of the ring elements are designed as holding elements and/or some of the ring elements are designed as fixing elements. The structure of the clamping ring can therefore be designed very flexibly. Inhibiting elements and fixing elements can be combined with each other, as the inhibiting elements can also take on a holding function. Inhibiting elements and holding elements can also be combined with each other if a separate fixing element, for example a fixing ring, is arranged in the fitting. Furthermore, it is also possible for the ring elements to be designed only as inhibiting elements, with an additional fixing ring arranged in the pressing sleeve.

The previously described guiding elements of the holding elements and the protective elements of the fixing elements can contribute to fixing in addition to the cutting elements by also penetrating the pipe wall during pressing. This means that the number of fixing elements can be smaller than the number of holding elements.

The fitting described above can be designed to seal the pipe from the outside or from the inside.

For sealing from the outside, the sealing element is arranged in the chamber and lies on the outside of the surface of the pipe.

A support sleeve is provided for sealing from the inside and the sealing element is located on the outside of the support body. During assembly, the support body is pushed into the inside of the inserted pipe end and has a stabilizing effect during pressing. The sealing element then acts between the support body and the inside of the pipe.

Furthermore, the clamping ring can have cutting elements aligned against the direction in which the pipe to be inserted is pulled out, which are arranged in at least one of the ring elements designed as holding elements. The cutting elements partially penetrate the material of the pipe during pressing and lead to improved fixing of the pipe within the pressed fitting.

According to the invention, the above object is also solved by a system for connecting a fitting described above to a pipe, in which the amount of the extraction force is greater than the amount of the insertion force for inserting the pipe into the fitting. It is preferred that the amount of the pull-out force is preferably at least 20%, optionally at least 50%, preferably at least 80% and in particular at least 100% greater than the insertion force.

### BRIEF DESCRIPTION OF THE DRAWINGS

In the following, the invention is explained with reference to the drawing by means of examples of embodiments. The drawing shows

FIGS. 1a-1g an example of a clamping ring,

FIG. 2 the clamping ring in a flat arrangement from two sides,

FIG. 3 the clamping ring in a round arrangement,

FIGS. 4a-4c further views of the clamping ring,

FIG. 5 an example of a fitting with an inserted clamping ring,

FIG. 6 the fitting with inserted pipe before pressing,

FIG. 7 the fitting after radial pressing,

FIG. 8 cross-section of the fitting shown in FIG. 6,

FIG. 9 cross-section of the fitting shown in FIG. 7,

FIG. 10a the fitting before inserting the pipe,

FIG. 10b the fitting during inserting the pipe,

FIG. 10c the fitting during extraction of the pipe,

FIG. 11 a force-displacement diagram to illustrate the strength of the insertion force and the extraction force and

FIG. 12 another example of a fitting with inserted clamping ring.

### DESCRIPTION OF THE INVENTION

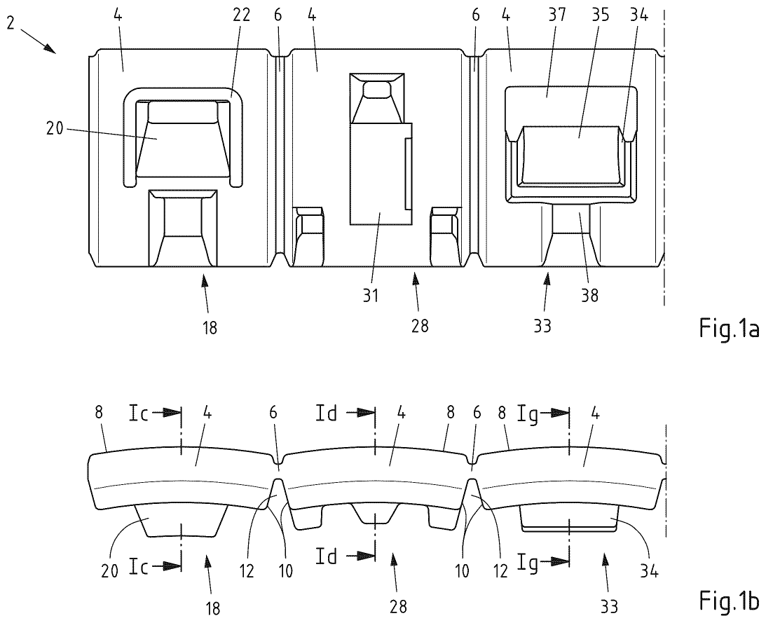

FIGS. 1 to 4 show an example of a clamping ring 2 in various views and positions.

The clamping ring 2 is suitable for a fitting for a pipe to be sealed from the outside, which is described below. The clamping ring 2 has a plurality of ring elements 4, each of which is pivotably connected to one another with hinge elements 6. The ring elements 4 are used to hold and/or fix a pipe to be inserted.

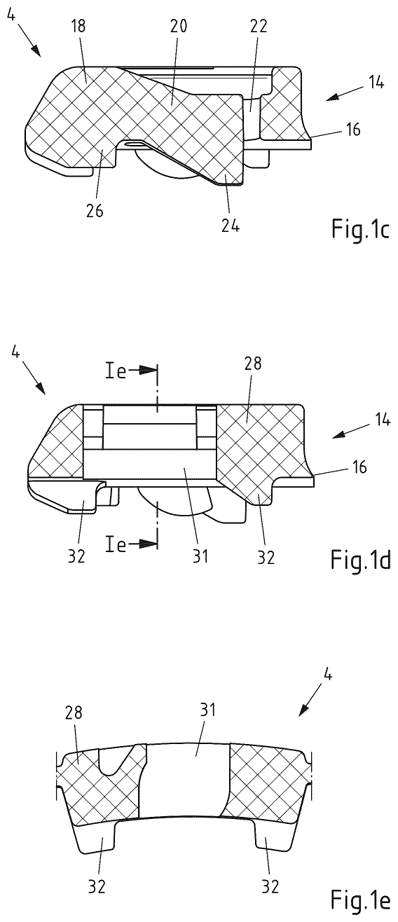

Furthermore, the ring elements 4 have a strip shape by means of the hinge elements 6, as can be seen in particular from FIGS. 1a, 1b and 2. The ring elements 4 can therefore assume a flat shape as in FIGS. 1a, 1b and 2, whereby “flat” essentially means that the ring elements 4 can rest on a surface.

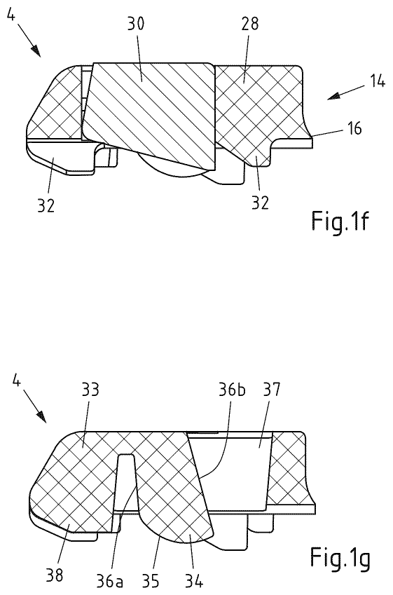

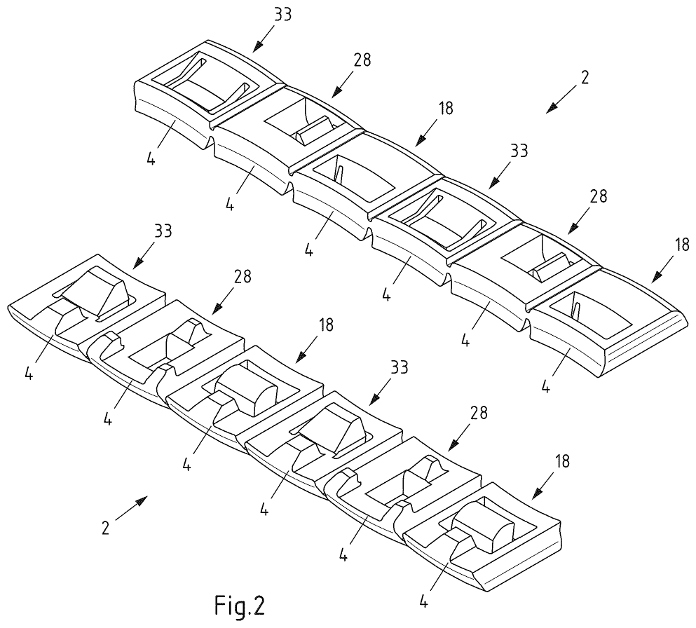

On the other hand, the ring elements 4 can also assume a laterally open ring shape as shown in FIGS. 3, 4a to 4c by means of the hinge elements 6. In the ring shape, the clamping ring 2 has a C-shape that is open on one side.

During the manufacture of the clamping ring 2 as a continuous product, for example as a product of a plastic extrusion process, the flat arrangement has the advantage that the ring elements 4 can be fitted with further elements in a simple manner if necessary, without a ring shape leading to complex process steps.

As can be seen from FIGS. 1 to 4, the ring elements 4 have a partially cylindrical outer surface 8, which is adapted to the cylindrical shape of the fitting or the chamber of the associated pressing sleeve. This allows the clamping ring 2 to lie flat against the fitting, at least in sections. In the flat shape of the clamping ring 2, the partially cylindrical outer surfaces then rest on a base in sections.

Furthermore, the ring elements 4 have lateral surfaces 10 in the azimuthal direction, which are tapered inwards towards each other in at least some sections in the radial direction. As a result, V-grooves 12 are formed between the ring elements 4 together with the hinge element 6. In FIG. 1b, the V-grooves 12 in the elongated flat shape of the clamping ring 2 are relatively wide, while in FIG. 4a, the V-grooves 12 in the curved ring shape of the clamping ring 2 are narrower, but still present.

The ring elements 4 also have a predetermined azimuthal length, so that the strip of hinge elements 6 can be cut into strips with at least two different numbers of ring elements 4 for at least two clamping rings 2 for fittings with at least two different nominal diameters. In this way, sections of different lengths can be cut from the continuously produced strand as clamping ring 2, which are then suitable in bent form for fittings with different nominal diameters. This feature is particularly advantageous with regard to the efficiency of production.

The following values are given as a possible example:
Nominal diameter NW28: Inner diameter D=35 mm and circumference=109.96 mm (equal to length of clamping ring)
Nominal diameter NW35: inner diameter D=42 mm and circumference=131.95 mm (equal to the length of the clamping ring)

With a ring element length of 11 mm, this means that 10 elements=110 mm can be used for nominal width NW28 and 12 elements=132 mm for nominal width NW35.

The ring elements 4 also have a seal seat 14 at the end facing a seal to be inserted, which is formed by an axially protruding holding element 16. The seal seat 14 secures the position of the seal within a fitting both before and after the fitting is pressed.

As can already be seen directly from FIG. 1a, the ring elements 4 are designed differently. Before discussing the inhibiting elements according to the invention, the supplementary designs of the ring elements as holding elements and fixing elements are first explained.

On the one hand, the ring elements 4 are partially designed as holding elements 18 and have radially inwardly directed elastic guiding elements 20 for centering and, if necessary, holding a pipe to be inserted. The spring elements 20 are designed in such a way that defined assembly forces and an improved pipe holding function are achieved.

According to FIGS. 1a and 1c, the guiding elements 20 are machined out of the material of the holding element 18 by means of a recess 22 extending on three sides and are therefore elastically resilient. Directed radially inwards, the guiding elements 20 have protruding wedges 24, which lie against the pipe to be inserted and guide it, as can be seen in FIG. 1c.

Guiding elements 26 projecting less radially inwards are formed offset in the axial direction to the guiding element 20. This means that when a pipe is inserted (coming from the right in FIG. 1c), a first centring is performed by the guiding element 26 and a second centring is performed by the guiding element 20 with the wedge 24 or wedges 24. In particular, pipes placed at an angle are centered and optimally arranged in the fitting by these differently pronounced guides. The distal guiding element 26 therefore protrudes less inwards than the proximal guiding element 20 as seen from the fitting. When the pipe is fully inserted, the guiding elements 20 and 26 hold the inserted pipe.

On the other hand, and as an alternative to the holding elements 18, a further part of the ring elements 4 is designed as fixing elements 28 and each has at least one cutting element 30 for fixing a pipe to be inserted, as shown in FIG. 1f. For this purpose, the fixing element 28 has a recess 31 shown in FIGS. 1a, 1b, 1d and 1e, into which the cutting element 30 is inserted. In FIGS. 1a, 1b, 1d and 1e, the fixing element 28 is shown without cutting element 30 and in FIG. 1f with cutting element 30. The cutting element 30 is preferably made of metal and fixes an inserted pipe after pressing before the pipe is pulled out of the fitting.

The fixing elements 28 shown also have protective elements 32 arranged in the circumferential direction next to the cutting element 30, which project further inwards in the radial direction than the cutting elements 30. The protective elements 32 thus protect the pipe during insertion and against unintentional damage to the surface during pressing.

The embodiment example of FIGS. 1 to 4 shows a further possible embodiment of the ring elements 4 in the form of inhibiting elements 33 according to the invention. The inhibiting elements 33 each have a radially inwardly directed cam 34, which is designed to be elastically deformable outwards in the radial direction, in FIG. 1g upwards. In the installed state, which is explained further below, the locking element 33 is in contact with the inner wall of the pressing sleeve on the outside, so that the deformation of the cam 34 means less bending and more a change in shape.

The cam 34 has a radially inwardly directed curved surface 35, in FIG. 1g directed downwards. The surface 35 thus faces the pipe to be inserted, as will be shown in detail below.

Furthermore, the cam 34 is inclined at an angle of less than 90° to the axis of the pipe to be inserted in the direction of insertion of the pipe (from the left in FIG. 1g). This inclined alignment results from the inclined surfaces 36a and 36b of the cam 34.

For the described deformability of the cam 34 and the freedom of movement required as a result, the locking element 33 has a recess 37 on at least one side.

In addition, a further guiding element 38 is provided for centering the pipe during insertion, the inner surface of which projects less inwards than the cam 34.

As can be seen from FIGS. 1a and 1b as well as 2 to 4a to 4c, some of the ring elements 4 are designed as holding elements 18, some of the ring elements 4 are designed as fixing elements 28 and some are designed as inhibiting elements 33. The holding elements 18, the fixing elements 28 and the inhibiting elements 33 alternate with one another so that they are evenly distributed around the circumference. In this embodiment example, the number of holding elements 18 is therefore equal to the number of fixing elements 28 and equal to the number of holding elements 33.

In principle, the clamping ring 2 can be of any design. On the one hand, the clamping ring 2 can only have inhibiting elements 33. On the other hand, the clamping ring 33 can also have at least one holding element and/or at least one fixing element 28 in addition to holding elements 33.

As shown in FIGS. 3 and 4a, the strip of clamping ring 2 is bent into a round clamping ring 2, with its side ends forming an open area at the point marked with arrow A.

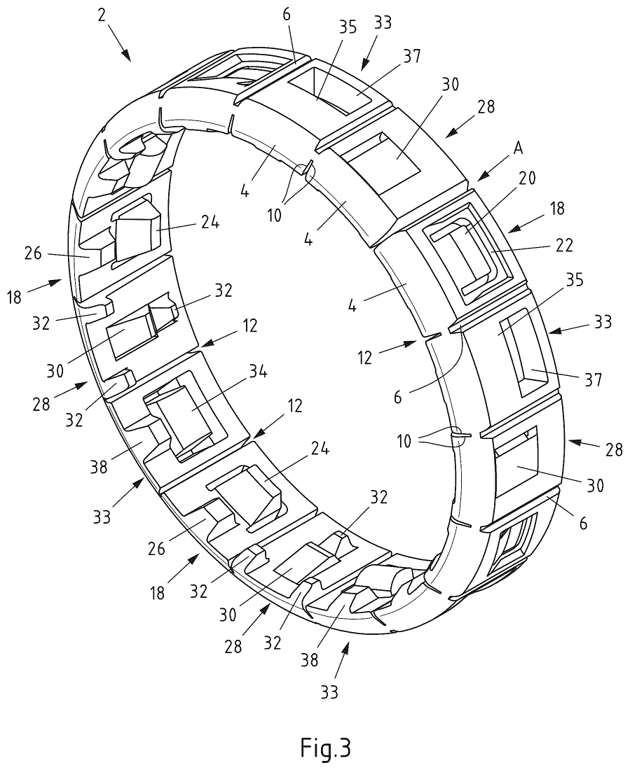

FIGS. 5 to 10 show an embodiment example of a fitting 40 for a connection with a pipe 42 to be sealed from the outside. The fitting 40 has a base body 44 and a stop element 46 in the form of a tapered diameter which is formed in the base body 44 on the circumference and projects inwards. Furthermore, a pressing sleeve 48 connected to the base body 44 is provided, the pressing sleeve 48 having a chamber 50 directed inwards towards the pipe 42 to be received.

The clamping ring 2 shown in FIGS. 1 to 4 is arranged in the chamber 50. As described, the clamping ring 2 is made of a plastic and has a plurality of ring elements 4. A sealing element 52 is arranged in the chamber 50 adjacent to the stop element 46, which is designed as an O-ring in the present case.

Together with the clamping ring 2, the ring elements 4 and the sealing element 52, the pressing sleeve 48 is suitable for sealing and fixing the pipe 42 to be connected from the outside.

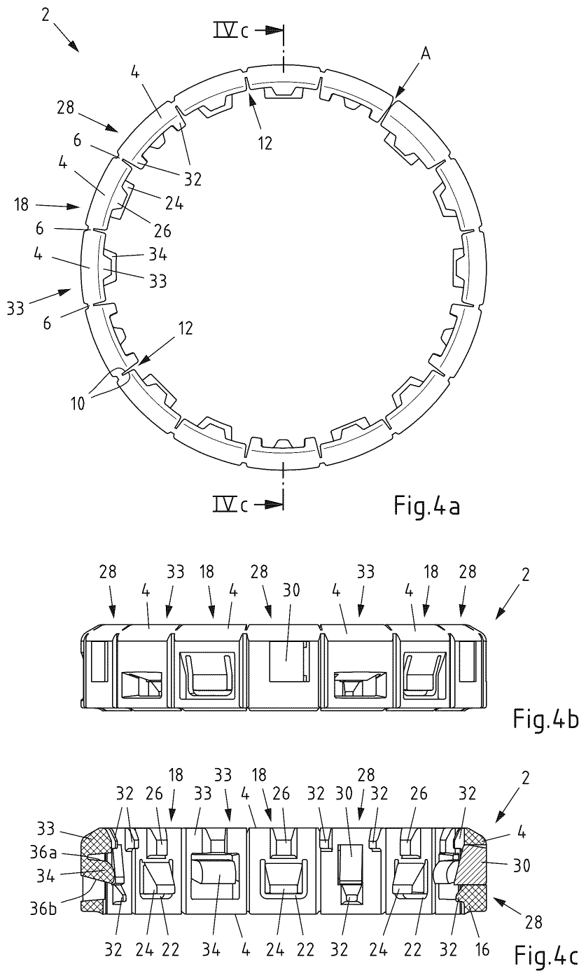

FIG. 5 shows the fitting 40 in a cross-section that runs through the ring elements 4 arranged at the top and bottom of the chamber 50. An inhibiting element 33 is provided at the top left of the cross-section, a holding element 18 is arranged at the top right and fixing elements 28 are arranged in both pressing sleeves at the bottom left and right. The inhibiting elements 33, the holding elements 18 and the fixing elements 28 correspond to the ring elements 4 shown in FIGS. 1 to 4. The fixing element 28 has the inwardly projecting cutting element 30. FIG. 6 shows the same fitting 40 as FIG. 5 with inserted pipe 42 in the unpressed state.

According to FIG. 6, as explained above, the guiding elements 20, 24 and 26 of the holding element 18 (shown above) hold and center the pipe 42 during insertion and before pressing.

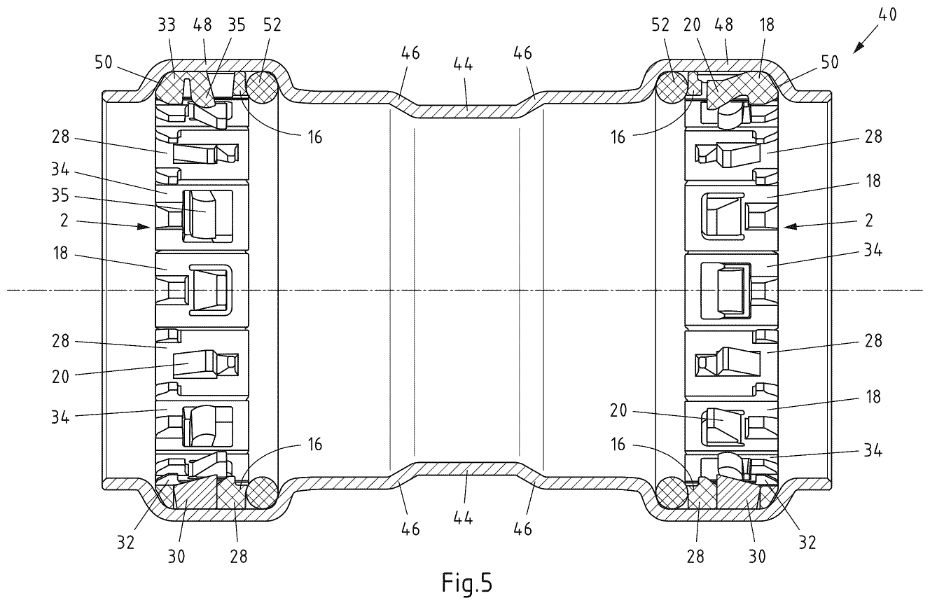

FIG. 7 then shows the fitting 40 in the pressed state, which is produced by the pressing tool 60. In particular, the integrated cutting elements 30 have penetrated the material of the pipe 42 after pressing as shown in FIG. 7 and fix the pipe 42 in the fitting 40.

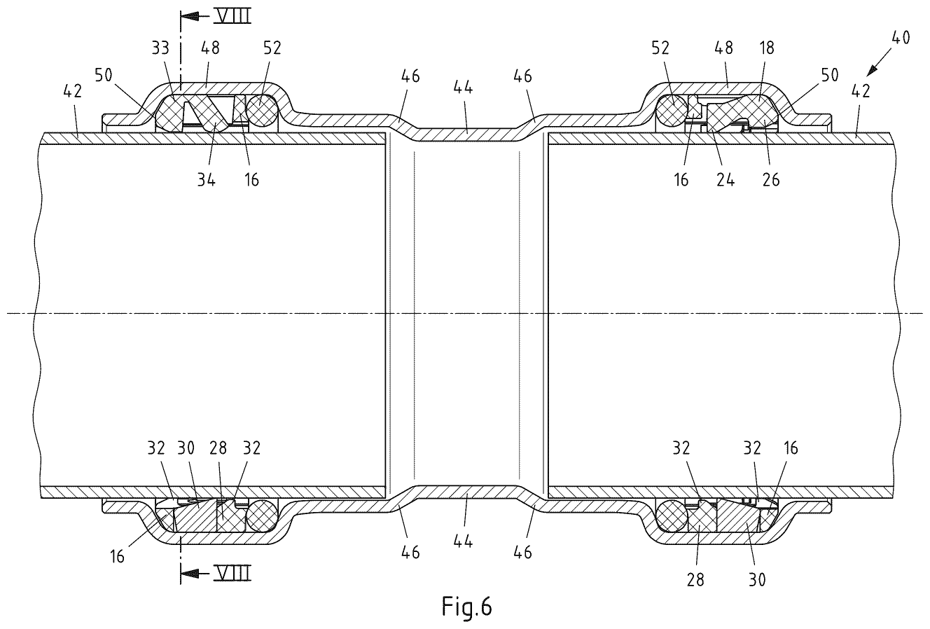

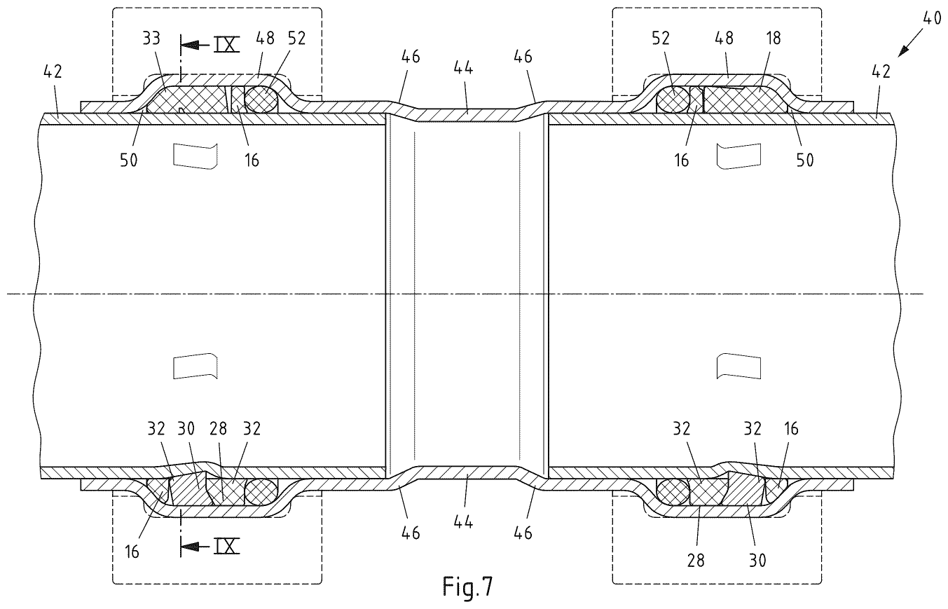

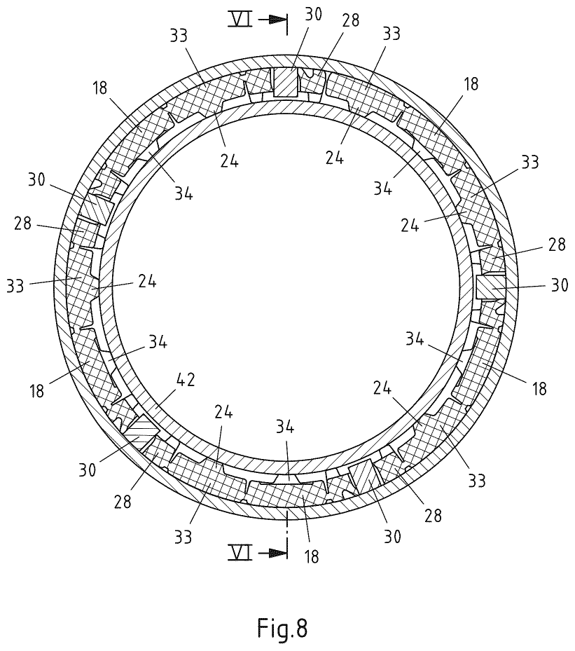

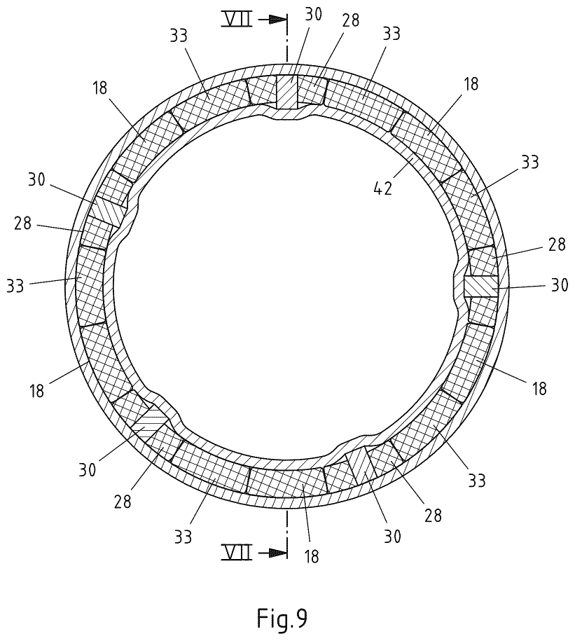

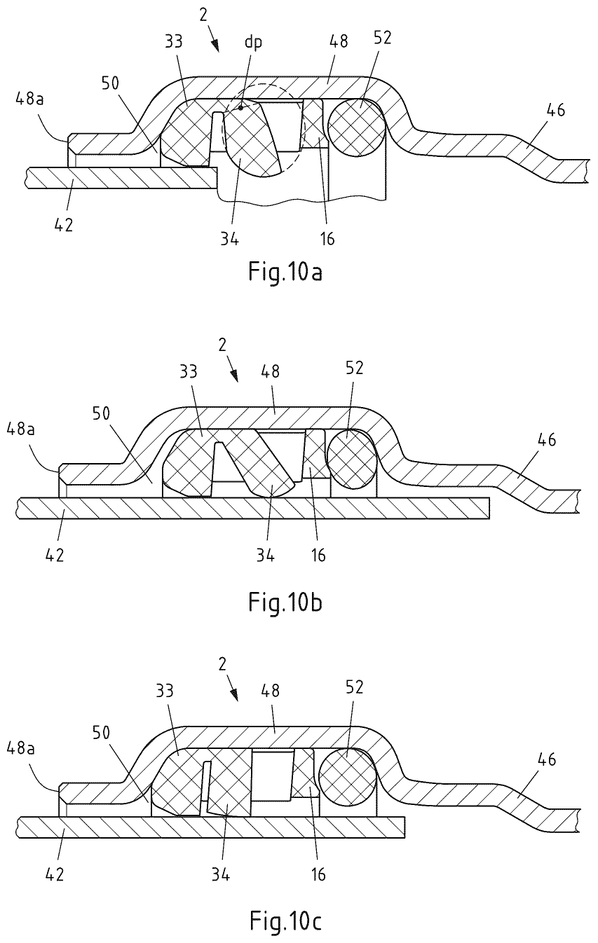

FIGS. 8 and 9 each show a cross-section of the fitting 40 in the area of the pressing sleeve 48 with chamber 50. In the unpressed state shown in FIG. 10a, the clamping ring 2 is arranged inside the chamber 50 and the ring elements 4 in the form of alternating inhibiting elements 33, holding elements 18 and fixing elements 28 are in contact with the inside of the chamber 50.

FIG. 9 shows the pressed state in which the pressing sleeve 48 has been formed radially inwards by a pressing tool 60 not shown here, see FIG. 7 with dashed lines. The reduction in diameter leads on the one hand to a reduction in the distance between the inhibiting elements 33, the holding elements 18 and the fixing elements 28, which are now in contact with each other, and on the other hand to a penetration of the cutting elements 30 into the wall of the pipe 42, which is thus deformed radially inwards. This fixes the pipe 42 within the fitting 40 and secures it against being pulled out or pushed out and against axial rotation.

FIGS. 10a to 10c show a section of the fitting 40 with a pipe to be inserted and with an inserted pipe 42, whereby the inhibiting element 33 is shown in the cross-section shown. A comparison between FIGS. 10a, 10b and 10c shows the effect of the locking element 33 with the cam 34, which is connected to the pipe 42 by means of static friction.

FIG. 10a shows the state before insertion of the tube 42, which is at an axial distance from the fitting 40 and from the inhibiting element 33. The cam 34 has the already described radially inwardly directed curved surface 35. As can be seen from the dashed auxiliary line, the shape of the cam 34 is elliptical in cross-section in some sections. The curved shape here therefore corresponds to a partial elliptical shape. FIG. 10a also shows the eccentric pivot point dp around which the cam 34 rotates during the deformation when the tube is inserted, whereby this movement is not a pure rotary movement but also has deformation components.

FIG. 10b shows the state after insertion of the pipe 42, which rests against the stop element 46, i.e. is arranged in the intended position for pressing. The cam 34 is in contact with the surface of the pipe 42 and is bent slightly outwards from its initial position. This creates increased contact pressure between the cam 34 and the pipe 42. Due to the static friction, the clamping ring 2 and with it the locking element 33 has been displaced axially into the pressing sleeve 48. This displacement is also evident from the slight deformation of the sealing element 52 and the small gap between the holding element 33 and the distal wall of the chamber 50.

When the pipe 42 is pulled out again after it has been pushed in, the inhibiting element 33 with the cam 34 is further deformed and compressed by the pipe 42, as the inhibiting element 33 does not have sufficient space for an evasive movement within the chamber 50. This state is shown in FIG. 10c. Due to the further increase in static friction, the pipe 42 presses the cam 34 in an axial direction towards the distal end 48a of the pressing sleeve 48, which produces an even greater deformation. The force required to pull it out is therefore significantly greater than when the pipe 42 is pushed in.

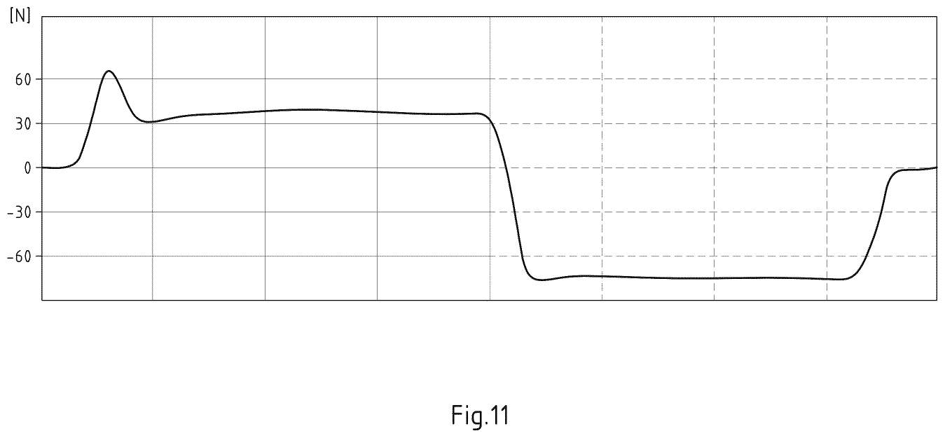

FIG. 11 shows a force curve for pushing a pipe 42 into and pulling it out of the fitting 40 with a clamping ring 2, which has inhibiting elements 33. The left half of the force curve shows the insertion of the pipe 42 with a force of approximately 33 N. At the beginning of the force curve, a brief maximum of approx. 65 N can be seen, which is required to push the cams 34 outwards and to overcome the static friction between the stationary pipe 42 and the holding elements 33 or their cams 34.

After the pipe 42 has been pushed into the fitting 40 as far as the stop 46, the force drops to 0 N, after which the extraction process begins immediately. Pulling out is shown with negative force values. The force to be applied is approximately −65 N, i.e. approximately twice as great as when the pipe 42 is pushed in.

The described design of the cams 34 of the inhibiting elements 33 results in the asymmetrical force curve shown. Insertion only requires the cams 34 to be deflected radially outwards. When they are pulled out, the cams 34 are deformed further inside the chamber 50 and form a greater resistance for the pipe 42, which leads to the higher pull-out force.

The inhibiting elements 33 therefore lead to improved self-locking of the pipe 42 in the fitting 40.

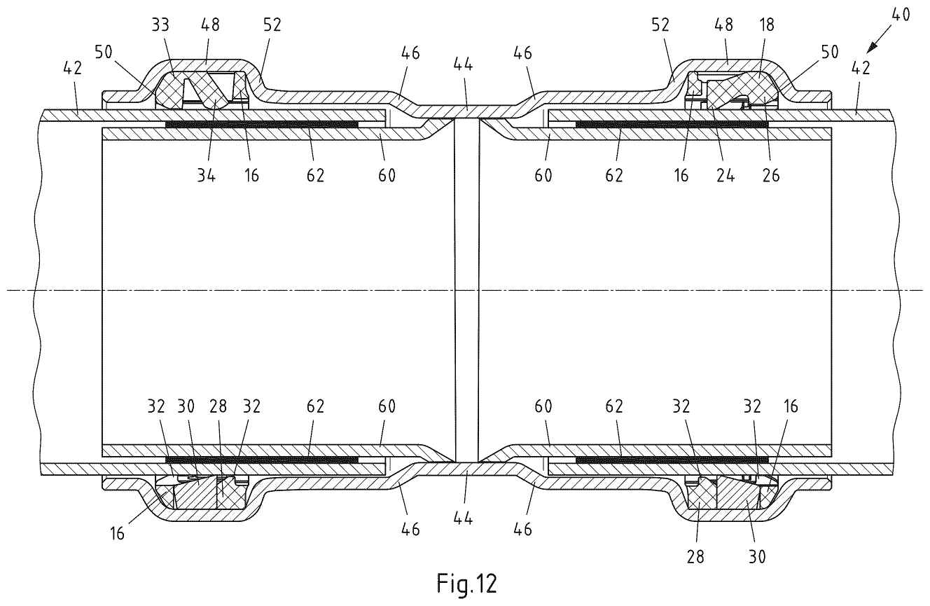

FIG. 12 shows a further example of a fitting 40 for a connection with a pipe 42 to be sealed from the inside. In this case, the chamber 50 only contains the clamping ring 2 with the ring elements 18, 28 and 33, as explained with reference to FIGS. 5 to 10a. The base body 44 is also connected to a support sleeve 60, which engages in the interior of the pipe 42. A sealing element 62 is provided on the outside of the support sleeve 60, which seals the pipe 42 from the inside after the fitting 40 has been pressed.

1. A clamping ring for a fitting for a connection with a pipe,
with a plurality of ring elements,
wherein the ring elements are designed to hold and/or fix a pipe to be inserted, wherein
at least one ring element is designed as an inhibiting element with a radially inwardly directed cam,
the cam is elastically deformable outwards in the radial direction, and
the cam has a radially inwardly directed curved surface.

2. The clamping ring according to claim 1, wherein
the cam is inclined at an angle of less than 90° to the axis of the pipe to be inserted in the direction of insertion of the pipe.

3. The clamping ring according to claim 1, wherein
at least three inhibiting elements with cams are provided and
the cams form a diameter smaller than the outer diameter of the pipe to be inserted on the radially inward side.

4. The clamping ring according to claim 1, wherein
in that a plurality of hinge elements is provided for pivotably connecting two ring elements in each case,
in that the ring elements have a strip shape by means of the hinge elements, and
the ring elements can assume a flat shape or a laterally open ring shape.

5. The clamping ring according to claim 1, wherein
the ring elements are formed in one piece as a ring open on one side.

6. The clamping ring according to claim 1, wherein
the ring elements are partially designed as holding elements and
the holding elements have radially inwardly directed, preferably elastically designed guiding elements for centering and, if necessary, holding a pipe to be inserted.

7. The clamping ring according to claim 1, wherein
the ring elements are partially designed as fixing elements and
the fixing elements each have at least one cutting element for fixing a pipe to be inserted.

8. The clamping ring according to claim 1, wherein
a part of the ring elements are designed as holding elements and/or a part of the ring elements are designed as fixing elements and/or a part of the ring elements are designed as inhibiting elements.

9. A fitting for a connection with a pipe,
with a base body,
with a stop element formed in the base body on the circumference and projecting inwards,
with a pressing sleeve connected to the base body, the pressing sleeve having a chamber directed inwards towards the pipe to be received,
with a clamping ring arranged in the chamber, the clamping ring consisting of a plastic and having a plurality of ring elements, and
with a sealing element,
wherein the pressing sleeve is suitable for sealing the pipe to be connected together with the clamping ring and the sealing element, wherein
that the clamping ring is designed according to claim 1.

10. A system for connecting a fitting to a pipe,
wherein the fitting is designed according to claim 9,
wherein the amount of the pull-out force is greater than the amount of the push-in force for pushing the pipe into the fitting.

11. The system according to claim 10, wherein
the amount of the pull-out force is preferably at least 20%, optionally at least 50%, preferably at least 80% and in particular at least 100% greater than the push-in force.
